(19) United States
(12) Patent Application Publication
(10) Pub. No.: US 2003/0023973 A1
(43) Pub. Date: Jan. 30, 2003

(54) Live on-line advertisement insertion object oriented system and method

(76) Inventors: Brian Monson, Carmel, IN (US); Michael Harris, Arlington, VA (US)

Correspondence Address: BAKER & DANIELS, 300 NORTH MERIDIAN STREET, SUITE 2700, INDIANAPOLIS, IN, 46204-1782, US

(21) Appl. No.: 10/105,064

(22) Filed: Mar. 22, 2002

Related U.S. Application Data
(60) Provisional application No. 60/277,821, filed on Mar. 22, 2001.

(51) Int. Cl. G06F 17/60; H04N 7/025; H04N 7/10

(52) U.S. Cl. 725/34; 725/32; 705/14

(57) ABSTRACT

The present invention involves a system and method of inserting advertisements into the live on-line broadcast information. A computer has a media player for presenting information to a computer user. The computer also has an interface to a computer network capable of transferring live broadcast information. The system receives at least one advertisement which is capable of insertion into the live broadcast information, and stores the insertable advertisement in the computer. The live broadcast information is presented to the computer user by the media player. The live broadcast is monitored to determine portions of the live broadcast suitable for insertion of the insertable advertisement. The media player then presents the insertable advertisement to the computer user. The live broadcast information includes signals indicating an insertion portion which is suitable for insertion of an advertisement. The system logs the presentation of the insertable advertisement, as well as the completion of the presentation of the insertable advertisement.

This application claims the benefit of U.S. Provisional Application No. 60/277,821 filed on Mar. 22, 2001.

### BACKGROUND OF THE INVENTION

1. Field of the Invention

The invention relates in general to streaming software for transmitting audio and audiovisual information over the global computer network. More specifically, the field of the invention is that of audio and audiovisual encoder software for converting programmed radio and television signals into digital format, software for transmission of audio and audiovisual information over the global computer network, player software for receiving and presenting audio and audiovisual information to a computer user, and reporting software for recording use of the player.

2. Description of the Related Art

Internet advertising involves the transmission and presentation of advertising material to the computer user. Conventionally, textual, visual, and audio material is codified into a network transportable format. The codified format may also include hypertext link to advertising material. The material in the codified format is translated by a client application browser and presented to a computer user on its network connected computer. The network connected computer translates the codified information and sends a request to an advertiser server to complete the translation of the hypertext reference. The advertiser server responds by sending appropriate advertising material to the network connected computer for incorporation into the information presented by the computer to the user. Often, the request for the advertising material includes information relating to the computer user so that targeted information can be presented to that user. In order to collect advertising fees, network advertisers typically require a log recording the number of times an advertisement was provided and presented to a computer user.

In addition to codified textual and visual material, computer networks can provide live audio and audiovisual material, similar to radio and television broadcasts. The network connected computer has a media player, for example a software program capable of receiving and translating the digital information to enable the user's computer to present the information in real time as an audio or audiovisual broadcast presentation. Typically, commercial radio and television broadcasts include commercial advertisements between programming portions. The software translates radio and television broadcasts into a codified format capable of transmission over a computer network, and computer-recognizable signals are also inserted to indicate portions of the broadcast where advertisements can be inserted. Similar to the textual material, targeted advertising material can also be provided for insertion into the codified audio and audiovisual material.

One problem is encountered with the insertion of advertisement into such broadcast information when the broadcast is live rather than predetermined. With live broadcasts, the portions where advertisements may be inserted are either not known in advance or can not be guaranteed to occur as scheduled. When such opportunities arise, the time constraints involved in obtaining and coordinating the insertion of the advertisement limit the ability of to make sure the advertisements are seamlessly presented to the computer user, and limit the effectiveness of recording and receiving advertising fees for the advertisements.

### SUMMARY OF THE INVENTION

The present invention involves a system and method of inserting advertisements into the live on-line broadcast information. An encoder computer converts the live on-air broadcast information into live on-line broadcast information. The system adds an advertisement insertion module to the media player of the network connected computer. The module obtains and stores on the user computer one or more advertisements from an advertisement computer while the media player is presenting the live on-line broadcast information. When a portion of the broadcast is suitable for the insertion of an advertisement, the system will present at least one advertisement to the computer user.

The user's computer has a media player for presenting information to a computer user. The computer also has an interface to a computer network capable of transferring live broadcast information. The system receives at least one advertisement which is capable of insertion into the live broadcast information, and stores the insertable advertisement in the computer. The live broadcast information is presented to the computer user by the media player. The user computer monitors the live on-line broadcast to determine portions of the live broadcast which are suitable the insertable advertisement. The media player then presents the insertable advertisement to the computer user.

The encoder computer transmits signals indicating an insertion portion which is suitable for insertion of an advertisement. The system logs the presentation of the insertable advertisement, as well as the completion of the presentation of the insertable advertisement, to the advertising server.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a schematic diagrammatic view of the station equipment, the encoding computer, and the streaming network using the present invention.

FIG. 2 is a schematic diagrammatic view of the user computer, streaming computer, advertising computer, ad serving computer, and web server computer using the present invention.

FIG. 3 is a flow chart diagram of the operation of the present invention relating to the initialization of an application (the “Player”) on the user computer.

FIG. 4 is a flow chart diagram of the operation of the present invention relating to the event processing of an application (the “Player”) on the user computer.

FIG. 5(a-d) are related flow chart diagrams of the operation of the present invention. FIG. 5a is a flow chart diagram of the operation of the present invention relating to the first encoder computer. FIG. 5b is a flow chart diagram of the operation of the present invention relating to the manual event processing. FIG. 5c is a flow chart of the present invention relating to additional (if present) encoder computers. FIG. 5d is a flow chart of the present invention relating to the insertion of events into the broadcast stream.

FIG. 6 is a flow chart diagram of the operation of the present invention relating to the event processing of an application (the “Player”) on the user computer.

FIG. 7 is an overview schematic diagrammatic view of a user computer and network arrangement using the present invention.

FIG. 8 is an overview flow chart diagram of the operation of the present invention relating to the operation of the user computer.

Corresponding reference characters indicate corresponding parts throughout the several views. Although the drawings represent embodiments of the present invention, the drawings are not necessarily to scale and certain features may be exaggerated in order to better illustrate and explain the present invention. The exemplification set out herein illustrates embodiments of the invention, in several forms, and such exemplifications are not to be construed as limiting the scope of the invention in any manner.

### DESCRIPTION OF THE PRESENT INVENTION

The embodiment disclosed below is not intended to be exhaustive or limit the invention to the precise forms disclosed in the following detailed description. Rather, the embodiments are chosen and described so that others skilled in the art may utilize their teachings.

The detailed descriptions which follow are presented in part in terms of algorithms and symbolic representations of operations on data bits within a computer memory representing alphanumeric characters or other information. These descriptions and representations are the means used by those skilled in the art of data processing arts to most effectively convey the substance of their work to others skilled in the art.

An algorithm is here, and generally, conceived to be a self-consistent sequence of steps leading to a desired result. These steps are those requiring physical manipulations of physical quantities. Usually, though not necessarily, these quantities take the form of electrical or magnetic signals capable of being stored, transferred, combined, compared, and otherwise manipulated. It proves convenient at times, principally for reasons of common usage, to refer to these signals as bits, values, symbols, characters, display data, terms, numbers, or the like. It should be borne in mind, however, that all of these and similar terms are to be associated with the appropriate physical quantities and are merely used here as convenient labels applied to these quantities.

Some algorithms may use data structures for both inputting information and producing the desired result. Data structures greatly facilitate data management by data processing systems, and are not accessible except through sophisticated software systems. Data structures are not the information content of a memory, rather they represent specific electronic structural elements which impart a physical organization on the information stored in memory. More than mere abstraction, the data structures are specific electrical or magnetic structural elements in memory which simultaneously represent complex data accurately and provide increased efficiency in computer operation.

Further, the manipulations performed are often referred to in terms, such as comparing or adding, commonly associated with mental operations performed by a human operator. No such capability of a human operator is necessary, or desirable in most cases, in any of the operations described herein which form part of the present invention; the operations are machine operations. Useful machines for performing the operations of the present invention include general purpose digital computers or other similar devices. In all cases the distinction between the method operations in operating a computer and the method of computation itself should be recognized. The present invention relates to a method and apparatus for operating a computer in processing electrical or other (e.g., mechanical, chemical) physical signals to generate other desired physical signals.

The present invention also relates to an apparatus for performing these operations. This apparatus may be specifically constructed for the required purposes or it may comprise a general purpose computer as selectively activated or reconfigured by a computer program stored in the computer. The algorithms presented herein are not inherently related to any particular computer or other apparatus. In particular, various general purpose machines may be used with programs written in accordance with the teachings herein, or it may prove more convenient to construct more specialized apparatus to perform the required method steps. The required structure for a variety of these machines will appear from the description below.

The present invention deals with “object-oriented” software, and particularly with an “object-oriented” operating system. The “object-oriented” software is organized into “objects”, each comprising a block of computer instructions describing various procedures (“methods”) to be performed in response to “messages” sent to the object or “events” which occur with the object. Such operations include, for example, the manipulation of variables, the activation of an object by an external event, and the transmission of one or more messages to other objects.

Messages are sent and received between objects having certain functions and knowledge to carry out processes. Messages are generated in response to user instructions, for example, by a user activating an icon with a “mouse” pointer generating an event. Also, messages may be generated by an object in response to the receipt of a message. When one of the objects receives a message, the object carries out an operation (a message procedure) corresponding to the message and, if necessary, returns a result of the operation. Each object has a region where internal states (instance variables) of the object itself are stored and where the other objects are not allowed to access. One feature of the object-oriented system is inheritance. For example, an object for drawing a “circle” on a display may inherit functions and knowledge from another object for drawing a “shape” on a display.

A programmer “programs” in an object-oriented programming language by writing individual blocks of code each of which creates an object by defining its methods. A collection of such objects adapted to communicate with one another by means of messages comprises an object-oriented program. Object-oriented computer programming facilitates the modeling of interactive systems in that each component of the system can be modeled with an object, the behavior of each component being simulated by the methods of its corresponding object, and the interactions between components being simulated by messages transmitted between objects.

An operator may stimulate a collection of interrelated objects comprising an object-oriented program by sending a message to one of the objects. The receipt of the message may cause the object to respond by carrying out predetermined functions which may include sending additional messages to one or more other objects. The other objects may in turn carry out additional functions in response to the messages they receive, including sending still more messages. In this manner, sequences of message and response may continue indefinitely or may come to an end when all messages have been responded to and no new messages are being sent. When modeling systems utilizing an object-oriented language, a programmer need only think in terms of how each component of a modeled system responds to a stimulus and not in terms of the sequence of operations to be performed in response to some stimulus. Such sequence of operations naturally flows out of the interactions between the objects in response to the stimulus and need not be preordained by the programmer.

Although object-oriented programming makes simulation of systems of interrelated components more intuitive, the operation of an object-oriented program is often difficult to understand because the sequence of operations carried out by an object-oriented program is usually not immediately apparent from a software listing as in the case for sequentially organized programs. Nor is it easy to determine how an object-oriented program works through observation of the readily apparent manifestations of its operation. Most of the operations carried out by a computer in response to a program are “invisible” to an observer since only a relatively few steps in a program typically produce an observable computer output.

In the following description, several terms which are used frequently have specialized meanings in the present context. The term “object” relates to a set of computer instructions and associated data which can be activated directly or indirectly by the user. The terms “windowing environment”, “running in windows”, and “object oriented operating system” are used to denote a computer user interface in which information is manipulated and displayed on a video display such as within bounded regions on a raster scanned video display. The terms “network”, “local area network”, “LAN”, “wide area network”, or “WAN” mean two or more computers which are connected in such a manner that messages may be transmitted between the computers. In such computer networks, typically one or more computers operate as a “server”, a computer with large storage devices such as hard disk drives and communication hardware to operate peripheral devices such as printers or modems. Other computers, termed “workstations”, provide a user interface so that users of computer networks can access the network resources, such as shared data files, common peripheral devices, and inter-workstation communication. Users activate computer programs or network resources to create “processes” which include both the general operation of the computer program along with specific operating characteristics determined by input variables and its environment.

The terms “desktop”, “personal desktop facility”, and “PDF” mean a specific user interface which presents a menu or display of objects with associated settings for the user associated with the desktop, personal desktop facility, or PDF. When the PDF accesses a network resource, which typically requires an application program to execute on the remote server, the PDF calls an Application Program Interface, or “API”, to allow the user to provide commands to the network resource and observe any output. The term “Browser” refers to a program which is not necessarily apparent to the user, but which is responsible for transmitting messages between the PDF and the network server and for displaying and interacting with the network user. Browsers are designed to utilize a communications protocol for transmission of text and graphic information over a world wide network of computers, namely the “World Wide Web” or simply the “Web”. Examples of Browsers compatible with the present invention include the Navigator program sold by Netscape Corporation and the Internet Explorer sold by Microsoft Corporation (Navigator and Internet Explorer are trademarks of their respective owners). Although the following description details such operations in terms of a graphic user interface of a Browser, the present invention may be practiced with text based interfaces, or even with voice or visually activated interfaces, that have many of the functions of a graphic based Browser.

Browsers display information which is formatted in a Standard Generalized Markup Language (“SGML”) or a HyperText Markup Language (“HTML”), both being scripting languages which embed non-visual codes in a text document through the use of special ASCII text codes. Files in these formats may be easily transmitted across computer networks, including global information networks like the Internet, and allow the Browsers to display text, images, and play audio and video recordings. The Web utilizes these data file formats to conjunction with its communication protocol to transmit such information between servers and workstations. Browsers may also be programmed to display information provided in an eXtensible Markup Language (“XML”) file, with XML files being capable of use with several Document Type Definitions (“DTD”) and thus more general in nature than SGML or HTML. The XML file may be analogized to an object, as the data and the stylesheet formatting are separately contained (formatting may be thought of as methods of displaying information, thus an XML file has data and an associated method).

In addition to text type of data, audio and visual information may be provided by data streaming techniques to deliver multimedia content. Streaming content is digitized content that has been compressed or encoded into a format that the server can break down into packets and then stream across a network to a player program. Streaming is a significant improvement over the download-and-play approach to multimedia file distribution because it allows content to be delivered to the end user as a continuous flow of data with little waiting time before playback begins. The content arrives, is buffered briefly, plays, and is discarded rather than being stored on the end user's computer. End users benefit by experiencing instant play—they do not have the frustration of waiting for content to download to determine whether it meets their needs or interests. Streaming data architectures and systems include player programs that run on an end users' computer to receive and render streaming multimedia content. In general, a player program such as this can support any one or a number of different network transport protocols, including UDP/IP, TCP/IP, HTTP, RTP, and IP multicast.

The present invention relates to such streaming content, and is shown generally in the schematic diagram of FIG. 7. User computer A100 may be a personal computer such as an IBM compatible or Macintosh personal computer, or other computer system having the ability to interact with a human operator. Computer A100 includes media player A200 such as the RealPlayer by Real Networks or the Microsoft Media Player by Microsoft. The computer user may activate media player A200 and access live broadcast information from streaming live media source A300 and presents that information to the computer user as a live audio or audiovisual through a computer monitor with speaker, or a similar device having the ability to provide radio or television like output. Insertable advertisements may be obtained from advertiser server A400 by sending a message requesting the insertable advertisement. Such a request may also include information about the computer user so that advertiser server A400 may provide targeted advertising.

In accordance with the present invention, insertion module A500 interacts with both media source A300 and advertiser server A400 (both of which are “network actors”) to coordinate the presentation and logging of advertisements in the live broadcast information by media player A200. Insertion module A500 may be integrated into media player A200 so as to present a single object to the network actors, or alternatively insertion module A500 may serve as an intermediary object to the communicate between the network actors and media player A200.

The procedure used by insertion module A500 is depicted in the flow chart of FIG. 8. Upon activation of media player A200 by the computer user to present live broadcast information in step 1000, and in step 1010 insertion module A500 pre-fetches an advertisement by obtaining at least one insertable advertisement from advertiser server A400. Step 1020 follows with the computer user watching the presentation of the live broadcast information by media player A200. Insertion module A500 also monitors the live broadcast information for portions of the broadcast which are suitable for having an advertisement inserted in step 1030. At some point in the live broadcast, insertion module A500 determines such a portion of the broadcast and enables media player A200 to present the pre-fetched advertisement in step 1040. Once media player A200 starts to present the advertisement, insertion module A500 logs the presentation of the advertisement in step 1050 by incrementing a counter of advertisement presentation and records the counter value. Insertion module A500 monitors the presentation of the advertisement to determine if media player A200 completes the presentation of the advertisement, and if so logs the completion by incrementing a counter of advertisement completions and records the counter value.

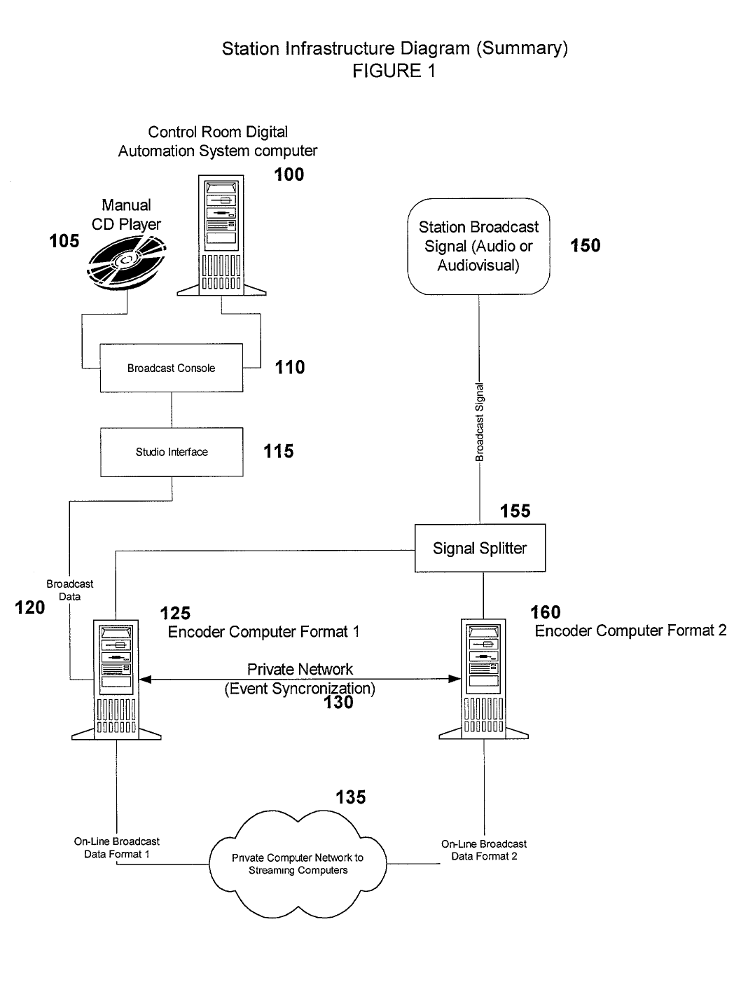

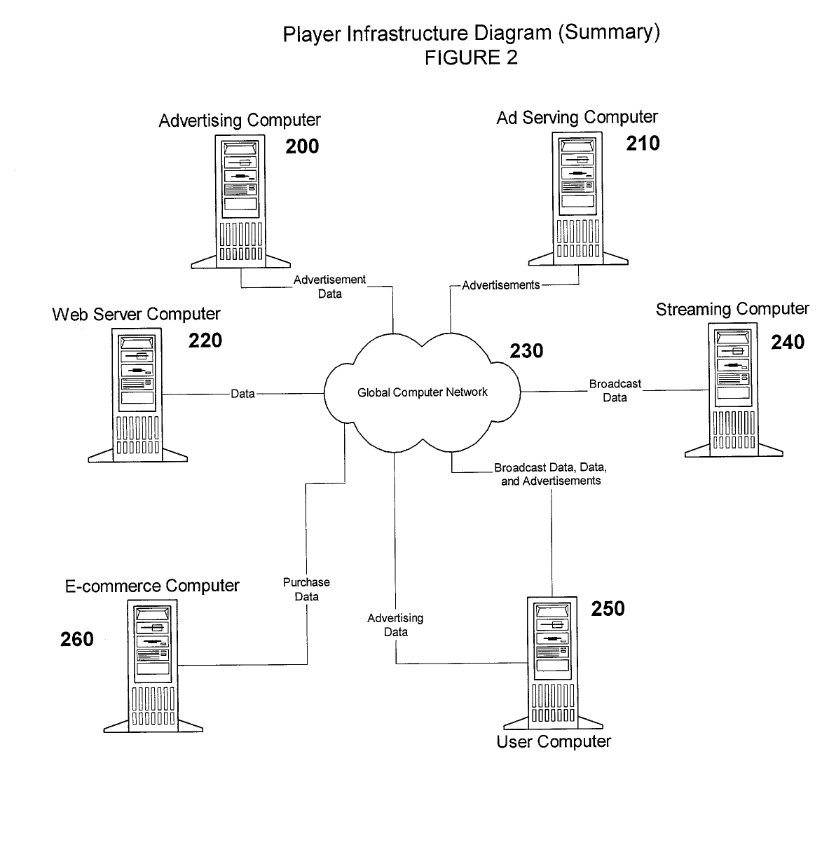

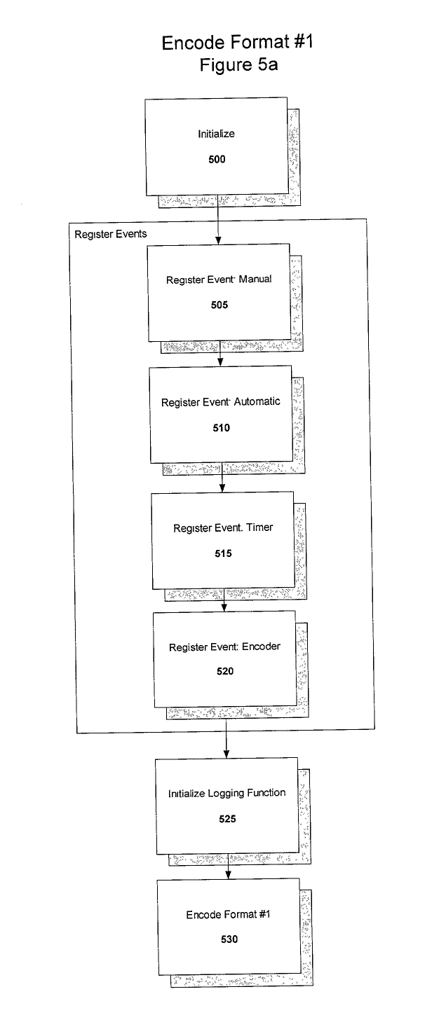

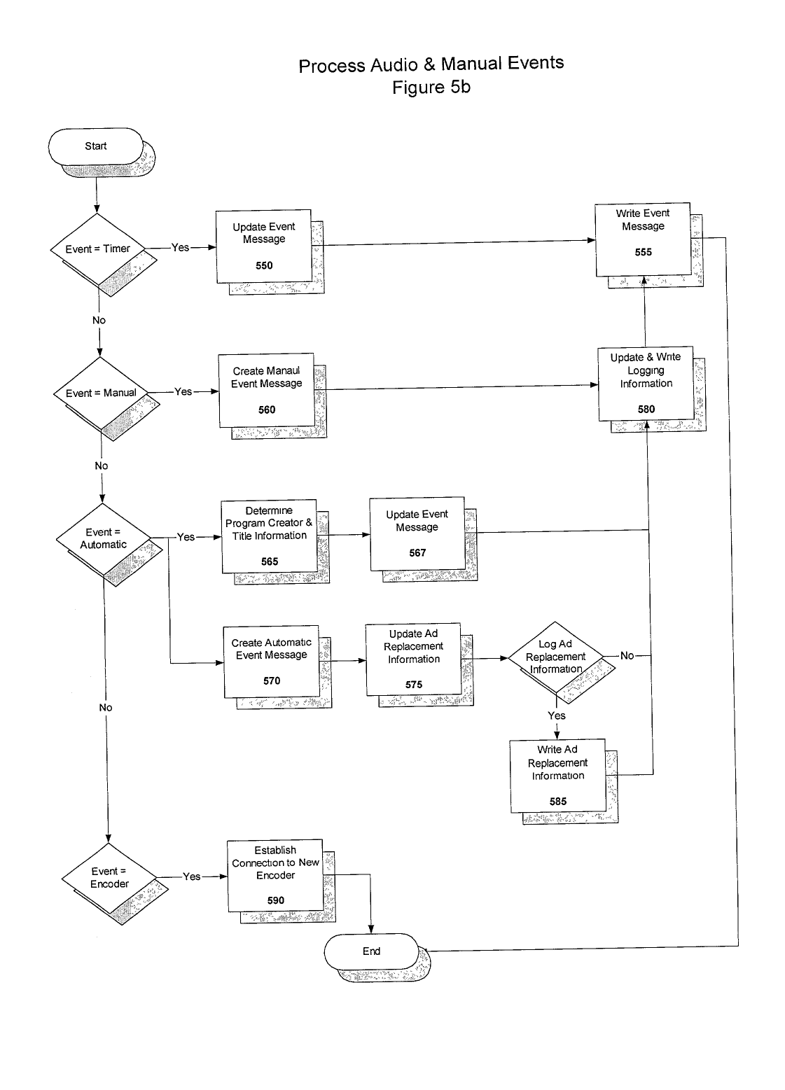

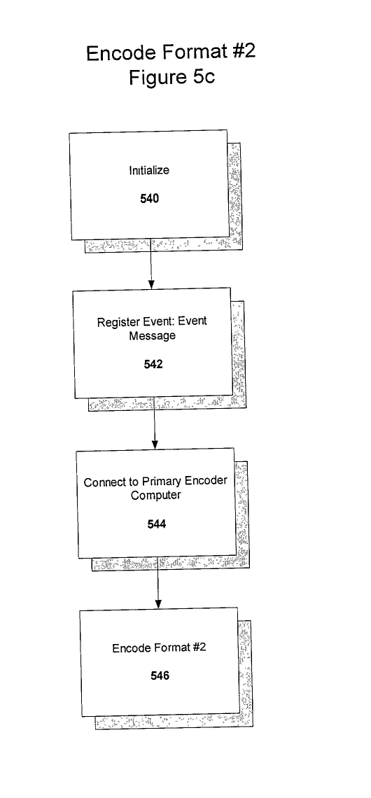

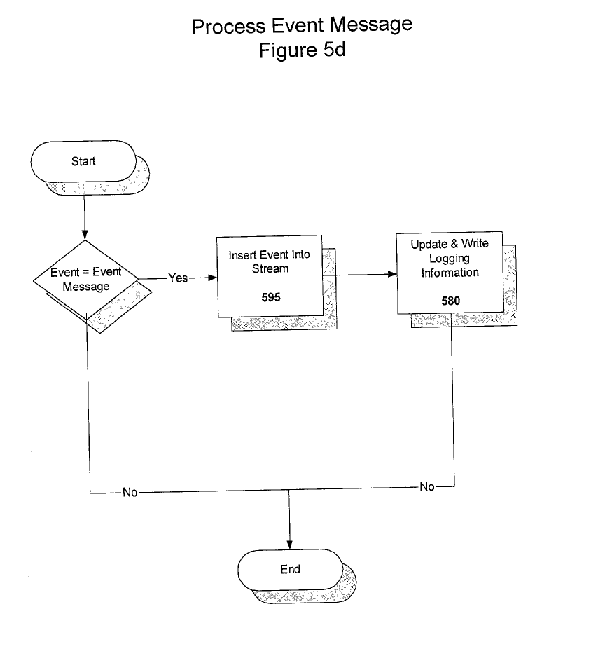

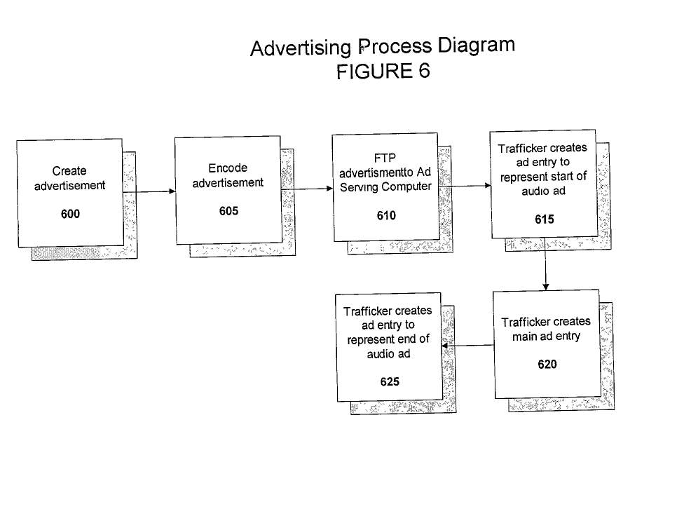

Although the preceding description provides a very general explanation of the invention, in more detail the invention includes three (3) independent but highly integrated components that form the basis of the system of which a specific embodiment is disclosed below. Component one, described in FIGS. 1, 5a, and 5b, is responsible for the creation of the synchronized audio or audiovisual signal. The synchronized signal consists of either audio or audiovisual information with embedded synchronized event information. Component two, described in FIGS. 6 and 7, establishes the advertisement inventory for the system consisting of audio or audiovisual information and data. Component three, described in FIGS. 2, 3, and 4, is responsible for integrating the information made available by components one and two into a single experience available to the end user through their computer.

Component one, referring to FIG. 1, the Station Infrastructure Diagram of the present invention preferably comprises Control Room Digital Automation System (DAS) computer [100], Encoder Computer Format 1 computer [125], zero or more Encoder Computer Format 2 [160] computers, and Programming Information computer [165]. Interfaces to the computer equipment referenced in FIG. 1 are as follows: a) Control Room Digital Automation System (DAS) computer [100] has either a standard Network Interface Card (NIC) with a RJ-45 connection or either a RS-232 or RS-422 serial connection, b) Encoder Computer Format 1 computer [125] has two standard Network Interface Card (NIC) with a RJ-45 connections, a standard RS-232 serial port, and one or more sound ports (with ¼″ phone tip ring sleeve or equivalent, c) Encoder Computer Format 2 [160] computer has one standard Network Interface Card (NIC) with a RJ-45 connections and one or more sound ports (with ¼″ phone tip ring sleeve or equivalent), d) Programming Information computer [165] utilizes a connection to the Internet.

Control Room Digital Automation System (DAS) computer [100] and Studio Interface [115] interface to Encoder Computer Format 1 computer [125] using a standard network connection (TCP/IP, RJ-45 or equivalent) or a null modem cable using either a RS-232 or RS-422 serial connector. Encoder Computer Format 2 [160] computers interface with Encoder Computer Format 1 computer [125] using a standard network connection (TCP/IP, RJ-45 or equivalent) using Private Network [130]. Encoder Computer Format 1 computer [125] interfaces with Programming Information computer [165] via the Internet. Audio from Station Broadcast Signal (Audio or Audiovisual) [150] is split by Signal Splitter [155] and made available to Encoder Computer Format 1 computer [125] and Encoder Computer Format 2 [160] computers through the sound ports on each computer. As previously stated, in accordance with the current invention, audio or audiovisual information [150] sent directly to Encoder Computer Format 1 computer [125] and Encoder Computer Format 2 [160] computers where it is encoded into one or more formats; event information received by Encoder Computer Format 1 computer [125] from Control Room Digital Automation System (DAS) computer [100] and Studio Interface [115] is sent to Encoder Computer Format 2 [160] computers; then Encoder Computer Format 1 computer [125] and Encoder Computer Format 2 [160] computers insert the event information into the audio or audiovisual encoded stream to create a synchronized audio stream or a synchronized audiovisual stream depending upon the signal being broadcast by the station.

Control Room Digital Automation System (DAS) computer [100] may be of any type, make, or model currently utilized, or contemplated to be used in the future, by the Broadcast Industry. Control Room Digital Automation System (DAS) computer [100] has the usual interfaces (e.g. serial ports or network interfaces) allowing event data to be passed to Encoder Computer Format 1 computer [125]. The event data consists of, for example, a cut identifier, cut name (i.e. artist name), and category (i.e. Rock or Country). The cut identifier is a unique identifier used by the Broadcast Station to identify the music and programming stored within their Digital Automation System.

Encoder Computer Format 1 computer [125] may be any type of computer system, for example personal computer (PC), a server based-system, a mini-computer, a stand-alone microprocessor or equivalent. Encoder Computer Format 1 computer [125] is configured with the standard operator interfaces and components, e.g. CDROM, memory, keyboard, and monitor (not shown in FIG. 1). The significance of Encoder Computer Format 1 computer [125] is it creates event messages and integrates those event messages into Station Broadcast Signal (Audio and Audiovisual) [150]. Additionally, the event messages are distributed to the zero, one, or more Encoder Computer Format 2 computers [160] for insertion into encoded Station Broadcast Signal [150]. The synchronized audio or audiovisual streams created by Encoder Computer Format 1 computer [125] and the zero, one, or more Encoder Computer Format 2 computers [160] are all in sync with each other and along with the data from Control Room Digital Automation System (DAS) computer [100].

Programming Information computer [165] contains a database that stores information about the audio or audiovisual content being broadcast by the Station. This information may include, but is not limited to, the album name, artist, and visual images for the album or, program name, producer, and display images for an audiovisual programming. The audio or audiovisual information is accessed using an identifier or set of identifiers that is defined by the Station, output by the Station's DAS, and stored within the programming information database. Note, the programming information database contains the information for one or many Stations utilizing the present invention.

FIGS. 5a and 5b illustrates a representation of the processing flow of the software functions performed by Encoder Computer Format 1 computer [125] in FIG. 1. Upon completion of Initialization [500] of the software the events handled by the software are registered. The software is non-deterministic or event driven and its processing is determined by the events generated by Control Room Digital Automation System (DAS) computer [100] and Studio Interface [115]. These events can be either automatic (i.e. controlled by the DAS) or manual (i.e. controlled by the operator or DJ). The events handled by the software include, but are not limited to, manual [505], automatic [510], timer [515], and encoder [520] events. Following the event registration, the software Initializes the Logging Function [525] then starts encoding the audio or audiovisual signal [530].

Initialization [500] function performed by the software running on Encoder Computer Format 1 computer [125] in FIG. 1 establishes the internal data structures used by the software to perform its function. Additionally, the interfaces to the external systems are verified to be available and operational.

Initialize Logging Function [525] performed by the software running on Encoder Computer Format 1 computer [125] in FIG. 1 verifies the existence of the logging files or creates the logging files if they do not exist. The logging function provides the capability to determine the number of advertisement events and the duration of the advertisements inserted into the synchronized audio or synchronized audiovisual stream for reporting, billing, and other purposes.

Encode Format #1 [530] function performed by the software running on Encoder Computer Format 1 computer [125] in FIG. 1 is used to convert Station Broadcast Signal (Audio or Audiovisual) [150] into a digital format for transmission over the Internet or other medium. The encoding of the audio or audiovisual broadcast signal continues indefinitely and is only interrupted momentarily to service the manual [505], automatic [510], timer [515], or encoder [520] events registered by the software. When the interrupt occurs, the event handler is called to service the event, and then control is transferred back to the encoder. Note, the encoder and the event handler software may be built as a single software application or they may be built at two separate software applications that run on Encoder Computer Format 1 computer [125].

FIG. 5b illustrates the processing flow of the event handler software function performed by Encoder Computer Format 1 computer [125] in FIG. 1. The event handler is capable of, but not limited to, processing the following events manual [505], automatic [510], timer [515], or encoder [520].

When an event of type Automatic is received for processing Determine Program Creator & Title Information [565] block of code is executed. Encoder Computer Format 1 computer [125] sends a request to Programming Information computer [165] requesting detailed information on the automatic event just starting to be broadcast by the station. The request contains a unique identifier or identifiers that uniquely identify the event in the programming information database. Examples of the request identifier may include, but not limited to, a program id, song id, or cart id. When the request returns (i.e. within 2 to 3 seconds) the event message is updated with the information returned from the programming information database; this is performed in Update Event Message [550] block in FIG. 5b. In order to minimize the amount of information inserted into the encoded broadcast stream, only the bare minimum of information is inserted into the stream. The information inserted into the encoded broadcast stream may include, but is not limited to, program name, URL to programming art or graphics, or a programming database reference id. The importance of the module is to associate additional programming information with the encoded broadcast stream using the minimal amount of information, not to resolve all references and insert the additional programming information into the encoded broadcast stream. The references will be resolved on User Computer [250] by the player software running on the computer.

Since the time needed to determine Program Creator & Title Information [565], a new event message is created [block 570] that does not contain the information from the programming information database. When the programming information becomes available, the event message is updated [block 550] and written to Private Network [130] using the software in Write Event Message [block 555] when the next timing event occurs. Information contained within the event message includes, but is not limited to, the following: sequence number, date-time stamp, event type, event duration, timing remaining in the event, event name, and URL to event graphics. The event types supported include, but are not limited to, replaceable advertisement, non-replaceable advertisement, station sold advertisement, live broadcast, general, and music. For events of type replaceable advertisement, non-replaceable advertisement, and station sold advertisement, a counter is maintained for the total duration of the ad type and written to the log file on a regular basis [block 585] (i.e. hourly, twice a day, or daily). The information written to the log file is important because it provides the ability to determine the total duration of ads, by type, for each station within the system. The information is used by the reporting and billing function within the system to reconcile the invoices received from the advertising software running on the Advertising Computer [200]. Update & Write Logging Information [580] code is executed to write an entry into the log file and the event message is written to Private Network [130] using the software in Write Event Message block [555].

When an event of type Manual is received for processing Create Manual Event Message [560] block of code is executed and an event message is created with same information as in the automatic event described above. The main difference between the automatic (scheduled) and the manual events (un-scheduled) is the manual events occur when the operator overrides the DAS (i.e. during an emergency broadcast). Both the automatic and manual events received and processed by Encoder Computer Format 1 computer [125] without needing any prior knowledge of the event.

When an event of type Timer is received for processing Update Event Message [550] block of code is executed. Update Event Message [550] code is responsible for updating the time remaining information in the event message to reflect the difference in time since the last timer event was received. That is, for example if the event time is set to 3 seconds, each time Update Event Message [550] code is executed the time remaining value in the event message will be decremented by 3 seconds. After the event message is updated it is written to Private Network [130] connection using the software in Write Event Message [555].

When an event of type Encoder is received for processing Establish Connection to New Encoder [590] block of code is executed. Establish Connection to New Encoder [590] code is responsible for establishing a connection for each Encoder Computer Format 2 [160] computer supported within the system. When the software on Encoder Computer Format 2 [160] computer initializes, the code in Connect to Primary Encoder Computer [544], FIG. 5c, is executed to request the event messages from Encoder Computer Format 1 [125] computer, code, Establish Connection to New Encoder [590]. The following table identifies the request message sent from Encoder Computer Format 2 [160] and the response message returned by Encoder Computer Format 1 [125].

For each request received by the Establish Connection to Encoder [590] software, the requesting Encoder Computer Format 2 [160] computer is added to a list of connected computers. When a timer event is received and the Write Event Message [555] code is executed, an event message is written to each encoder on the list of connected computers.

The Write Event Message code [555] is responsible for writing the event message to each and every encoder listening on the Private Network [130] connection.

| Item | Name | Parameter | Type | Size | Description |
|---|---|---|---|---|---|
| Initialization | Request | | | | Initialization request from Encoder application to |
| | | | | | Live Sync requesting event information. During |
| | | | | | initialization the encoder will issue an “Initialization |
| | | | | | Request” message to Live Sync over the Global |
| | | | | | Initialization Port. The Global Initialization Port is |
| | | | | | defined by Live Sync and passed to the encoder as a |
| | | | | | command line argument or through an initialization |
| | | | | | file Upon receipt of the “Initialization Request” |
| | | | | | Live Sync will establish an Event Broadcast Port, |
| | | | | | format an “Initialization Response” message, and |
| | | | | | send it back to the requesting encoder. |
| | | Type | String | 2 | Type of encoder being initialized, values: “WE” for |
| | | | | | Windows Media Encoder and “RE” for Real |
| | | | | | Encoder |
| | | ID | String | <256 | Encoder defined value (i.e. application generated, |
| | | | | | process id) |
| | | Name | String | <256 | Name assigned to application (i.e. passed through |
| | | | | | command line “WMP-56”) |
| | | Time- | String | 14 | Local Timestamp, format: |
| | | stamp | | | YYYYMMDDHHMMSS |
| | Response | | | | Response from the initialization request |
| | | ID | String | <256 | See ID description from Request message Copied. |
| | | Name | String | <256 | See Name description from Request message. |
| | | | | | Copied |
| | | Port | String | <10 | Set by Live Sync. Port number encoder will receive |
| | | | | | event information |
| | | Time- | Sting | 14 | Local Timestamp, format |
| | | stamp | | | YYYYMMDDHHMMSS |

FIG. 5c illustrates the processing flow of the software functions performed by zero, one, or more Encoder Computer Format 2 computers [160] in FIG. 1. Upon completion of Initialization [540] of the software the events handled by the software are registered [542]. The software is non-deterministic or event driven and its processing is determined by the events generated by Encoder Computer Format 1 computer [125]. The event handled by the software includes, but is not limited to, the event message insertion event. Following the event registration, the software Connects to Primary Encoder Computer [544] then starts encoding the audio or audiovisual signal [546].

When an event of type Event Message is received for processing Insert Event Into Stream [595] block of code is executed. This code is responsible for reading the event messages sent by Encoder Computer Format 1 [125] computer, read the event message, and write the message into the encoded broadcast signal. After writing the event message Update & Write Logging Information [580] block is executed to add an entry into the event log for the encoder.

FIG. 6 illustrates the processes surrounding the submission of advertisements. These advertisements can be composed of any form of electronic media that can be streamed across the Internet [230]. Example file types include audio advertisements, audio advertisements with corresponding text, audio advertisements with corresponding graphics, audiovisual advertisements, and proprietary file formats from third parties An advertising user decides to create an advertisement. For this invention, the advertising user decides what audience demographic the advertisement should be displayed (Targeting values), how many Impressions the advertisement should be viewed. (The term Impressions is used to represent the number of times an advertisement is presented to a computer user.) The advertising user acquires/creates [600] one or more advertisement and stores it on Ad Creation computer [700].

The advertising user must convert the advertisements into a format usable by other parts of this invention and must transfer advertising data to other computers in this invention. To facilitate, a software invention was created to automatically encode [605] the advertisement into one or more formats, and transfer [610] the advertisement by way of the global computer network [230] to one or more ad serving computers [210].

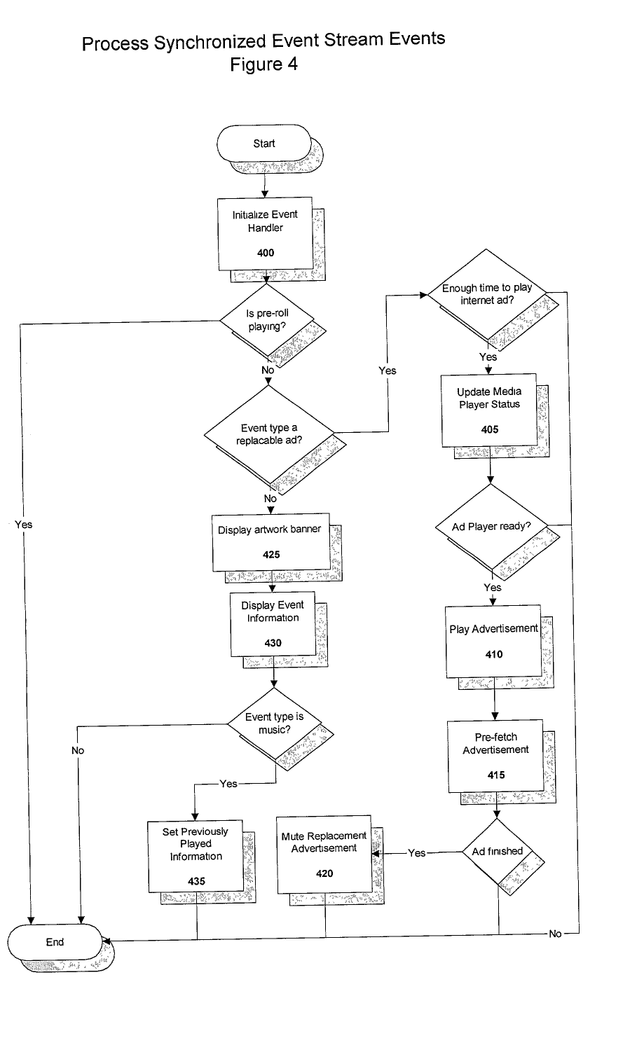

Ad Creation computer [700] is a standard computer comprising of a CPU, various forms of memory, a storage device, input/output devices, one or more sound cards, a network card, web browsing software, and software to convert advertisements to one or more formats. The advertisement resides in a storage device on Ad Creation computer [700]. The advertising user executes the invention software on the Ad Creation computer [700]. The invention software determines whether the file has been encoded into a compatible format. If not, the invention software encodes [605] the advertisement into at least one compatible streaming format. By way of example, the invention software will convert an audio file into both a Real and Windows Media streaming format and stores the converted file(s) on Ad Creation computer [700]. The invention software names resulting streaming formats by a standard naming convention. This naming convention allows the media player to identify the advertisement for download as defined by FIG. 4.

The invention software then automatically transfers the advertisements to one or more format-specific Ad Serving computers. The invention software uses a file transfer protocol to transfer one or more advertisement formats via global computer network [230] to Ad Serving computer [210]. In order for later parts of this invention to work, the software should put the advertisements into the correct directory on the Ad Serving computer. The directory in which each advertisement is placed is determined by using a unique code element to define the intended audio or audiovisual channel the advertisement is to be played on. These code elements are defined to allow this invention to work across more than 1 billion broadcasters.

The advertising user must then transfer information about the advertisement to Advertising Computer [200]. The advertising computer is a computer that runs advertising management software. This software system includes the functionality to serve advertisements to their intended recipients and report on the number of impressions and user actions (“Clicks”) that result. The advertising computer, by way of example, uses DoubleClick DART™ software (DART is a trademark of DoubleClick Inc.). Part of this invention involves the creative application of system design to record information about Cached Advertisements. A Cached Advertisement is an advertisement that is stored on the user computer prior to being presented to the user.

Advertising computers such as DART work on an ad request basis. User computer [250] or web server computer [220] typically requests an advertisement from the Advertising Computer by sending a coded message. The coded message often contains demographic information about the user that is used by the Advertising Computer to determine the most appropriate advertisement for the user. The Advertising Computer responds to the coded message request by serving an advertisement to user computer [250] or web server computer [220] and records an Impression for that advertisement. The Advertising Computer maintains two pieces of data for each advertisement: the number of impressions and the number of user-actions (e.g.: clicks). Advertisement performance is measured by the “click-through rate,” defined as the number of user-actions divided by the number of impressions.

The Advertising Computer records an Impression based on when the advertisement request is initiated by the user-computer. Typically, many advertisements (by way of example, simple GIF images) are presented to users very closely in time with the actual advertisement request. Due to bandwidth restrictions and its resulting affect on quality audio and audiovisual advertisements, these advertisements may be cached on the user computer. In this case, the advertisement request is followed by the Ad Server transferring the advertisement to the user computer. After the advertisement is on the user computer, a delay (by way of example, several minutes or hours) may occur before the advertisement is presented to the user. The display of the advertisement may be separated by considerable time from the request for data. During that time, the user may disconnect from the computer between the advertisement request and the advertisement presentation; therefore, the Advertising Computer may record an impression although an advertisement may not have been presented to a user

Part of this invention involves the user computer's media player transmitting additional data to the Advertisement Computer, in conjunction with the advertisement request, to properly record the true Impression of an advertisement. This process is defined in greater detail in FIG. 4. Audio and audiovisual advertisement presentation lapses over a period of time—the advertisements presentation takes more than one second to complete. By convention, an Impression is correctly recorded when any part of the advertisement is presented to the user. Many advertisers want to know the number of times their advertisement(s) were actually presented to users in their entirety. The ability to provide advertisers a guarantee that the entire advertisement was played without being terminated in the middle of presentation is called the Guaranteed Impression. The Guaranteed Impression also relies on the user computer's media player to transfer more information [FIG. 4]. The setup and configuration of the Advertisement Computer to correctly record this additional data is part of the invention.

The advertising user utilizes a web browser residing on Ad Creation Computer [700] to store data on advertising computer [200] via global computer network [230] to properly configure the Advertising Computer to use parts of this invention. This configuration involves creating three specially tagged advertisements in Advertising Computer [615, 620, 625] for each audio or audiovisual advertisement to record impressions, guaranteed impressions, and user actions.

The advertising user creates an ad entry [615] on Advertising Computer [200] to record the number of times a user responds (e.g.: “clicks” on) on the advertisement. The advertisement name will comply with a naming convention (by way of example, “-Ad Click”) to identify it to the advertisement user. The ad entry is created in such a way that the Advertising Computer will never match the Advertisement to an advertisement request, and will never be returned when an ad is requested from User Computer [250]. The Advertising Computer will never record an impression for this advertisement. The media player on the User Computer will record an action (e.g.: “Click”) for that advertisement every time the user performs an action on the advertisement. (FIG. 4) Thus, this ad will maintain a count of user actions in the “click” summary of the advertisement.

The advertising user will create second advertisement [620] on the Advertising Computer to record the guaranteed impression count. This ad will follow a naming convention, by way of example “-Comp Imp.” Like the previous advertisement, this ad is created in such a way that it never matches an advertisement request. This advertisement will not record any impressions. The media player on the User Computer will record an action (e.g: “Click”) for this advertisement every time the advertisement is completed. (FIG. 4). Thus, this ad will maintain a count of the number of times an advertisement is played through to completion.

The advertising user will create third advertisement [625] on the Advertising Computer as the advertisement with actual data. This ad will follow a naming convention, by way of example “-Prefetch/Starts.” This advertisement contains the information necessary to return advertisements to the media player on the user computer, and this advertisement contains information about the other two (reporting-only) advertisements.

This third advertisement contains text in a field that is interpreted by the media player on the user computer and is used by the media player to record user action in the first two advertisements. Information data is placed as parameters to the media player. Parameters include:

<audioStart“[path to update start ad statistics [615]]”>

<audioSrc=“[name of file (no extension) on Ad Serving Computer [210]]”>

<image=“[path to graphic displayed when ad is playing]”>

<imageClick=“[path to update main ad click statistics [620]]”>

<audioEnd=“[path to update end ad statistics [625]]”>

<ownerId=“[either the affiliate station id or LMiV (depending on who the ad slot was purchased from)]”>

The media player processing is described in detail in FIG. 4. The Impressions of this advertisement will be incremented every time an advertisement is requested and the advertisement matches the request. The Clicks on this advertisement indicate the number of times the ad actually started playing.

Component three, referring to FIG. 2, the Player Infrastructure Diagram of the present invention, comprises one or more computers connect to each other utilizing Global Computer Network [230]. The computers connect to Global Computer Network [230] include Advertising Computer [200], Ad Serving Computer [210], Web Server Computer [220], Streaming Computer [240], E-Commerce Computer [260], and User Computer [250]. The computer equipment referenced in FIG. 2 is connected to Global Computer Network [230] using a single standard Network Interface Card (NIC) with a RJ-45 similar connector. User Computer [250] may be a standard PC, with CPU, keyboard, mouse, and monitor, capable of running a Web browser.

The media player, part of the invention, resides on user computer [250] and is launched by the user in order to participate in the audio and audiovisual presentation. It is in the media player where the synchronized event stream (previously described, FIG. 1) and the advertisements store in Advertising Computer [200] (previously described, FIG. 7) are integrated to provide an audio and audiovisual presentation to the individual user with tailored advertisements delivered to the user based on personalized demographic information. The media player is where the guaranteed delivery of the advertisement is presented to the end user is performed. The following paragraphs define how the media play is initialized; pre-fetches advertisements based on user demographics, utilize the event information in the synchronized event stream to insert advertisements into the audio and audiovisual stream, and then the information is presented to the end user.

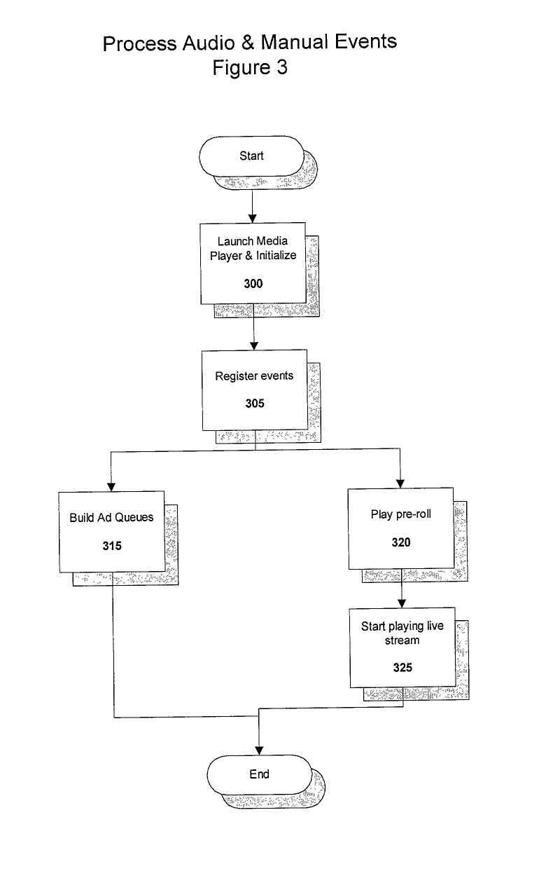

Upon receiving a request from the user to start the media player software code residing on web server computer [220] and on user computer [250] (by way of example, JavaScript) is executed and the media player become active and start the sequence of steps as defined in FIG. 3. When the media player is launched it is passed a set of parameters that define both the environment in which it will execute along with the demographic information of the user using the media player. Special care is taken to handle the syntax differences between web browsers. Web Server based code (by way of example, Java) compiled into libraries and applications (by way of example, Java servlets) create the user-computer based code dynamically based on parameters that are passed into the web server computer by other computer software and code [300]. Examples of the parameters passed to the media player include, but are not limited to, the path to the advertisements stored within Global Computer Network [230], the desired bandwidth of the audio or audiovisual stream to connect to, zip code of the user, ad query information, pre-roll ad query information, the number of 30 and 60 second ads to pre-fetch and maintain in the media player, and the demographic profile information for the user (i.e. age, income group, education group, and other interest areas).

Register Event [305] block of code is executed to allow the media player to handle events generated by the user interacting with the media player or events embedded with in the synchronized broadcast stream. These events are asynchronous; occurring at random, and are handled by the media player as they occur. Examples of the events handled by the media player include, but are not limited to, the following: event message events from the broadcast stream and volume up, volume down, mute, stop, and play events from the media player. The processing of the event message events is defined in FIG. 4 and described in detail in the following sections. For the purposed of this disclosure, the media player events are not defined.

Once the media player has initialized, it is ready to begin presenting audio and audiovisual information to the user. The media player uses the pre-roll ad query information and profile string to request a pre-rolled advertisement from Advertising Computer [200]. The ad request reports an Impression to the Advertising Computer when the advertising data is returned to the media player. A Pre-roll advertisement is an audio or audiovisual advertisement that appears before desired content. (eg: a Startup message). The media player, using the pre-roll advertisement file name contained in the result from the pre-roll ad request, initiates the pre-roll advertisement with Ad Serving Computer [210], thus playing the pre-roll advertisement on the media player.

When the media player begins playing the pre-roll advertisement, it signals the Advertising Computer and reports a “click” for the third (prefetch/start) advertisement. The Advertising Computer responds with a hyperlink to an advertisement, and the media player connects to that streaming computer [by way of example, 240]. When the media player completes playing the pre-roll advertisement, it reports a “click” for the second (Comp Imp) advertisement. If a user happens to have clicked on the player during the advertisement, that information is reported in the first (Click) advertisement.

Once the pre-roll advertisement start streaming (playing), Build Ad Queues [315] block of code is executed to build and load (i.e. pre-fetch) the replacement advertisements that will be inserted into the audio and audiovisual broadcast stream by the media player. Build Ad Queues [315] executes in parallel to the pre-roll advertisement and the playing of the broadcast audio and audiovisual stream to maintain a set of replacement advertisements for use by the media player. The number of 30 and 60 second ad queues is determined by the parameters passed to the media player during initialization. Similar to the pre-roll advertisement, the media player uses the ad query information and profile string passed to the media player to request a replacement advertisement from Advertising Computer [200]. Note that the ad request reports an Impression to the Advertising Computer when the advertising data is returned to the media player. A single request is made to Advertising Computer [200] for each ad queue maintained by the media player. The replacement advertisement returned by the request of Advertising Computer [200] contains an ad filename that is concatenated with the path to the advertisements parameter passed to the media player to form a valid full pathname to an advertisement on Ad Serving Computer [210]. By passing the path to the advertisements as a parameter to the media player allows the media player supporting different formats to access different advertising locations throughout Global Computer Network [230]. The advertisement is transferred from Ad Serving Computer [210] to the ad queue associated with the advertisement. The above steps are repeated until all the ad queues contain replacement advertisements.

Upon completion of Play Pre-roll [320] block of code Start Playing Live Stream [325] block of code is executed which translates the encoded broadcast signal into an audible signal that is played through the speakers (not shown) on or attached to User Computer [250] . As the media player plays the broadcast audio or audiovisual signal, the event message events embedded in the synchronized audio or audiovisual broadcast stream cause the media player to be interrupted and control passed to the Process Synchronized Event Stream Events, as shown in FIG. 4.

The event handler for the synchronized event stream is detailed in FIG. 4, Process Synchronized Event Stream Events. The event handler is called once for every synchronized event embedded into the audio or audiovisual broadcast stream created by Encoder Computer Format 1 [125] or Encoder Computer Format 2 [160] computers that is being listen to by a media player. The main purpose of the synchronized event message event handler is to insert replacement advertisements into the audio or audiovisual broadcast stream, at the precise time and location, as specified by the event message within the stream. Upon entering the event handler, Initialize Event Handler [400] code is executed to perform any initialization and to resolve all variable references used within the software. Since the software is asynchronous, all possible conditions are evaluated which may exist when the event handler is called. Such is the case with the first conditional check performed within the software to determine if the pre-roll advertisement is currently playing. If not performed, the event handler could possible start playing a replacement advertisement midway through the playing of the pre-roll advertisement.

After determining that a pre-roll advertisement is not playing, the event handler verifies whether or not the event being handle is a replaceable advertisement. If it is not a replaceable ad then Display Artwork Banner [425] and Display Event Information [430] code blocks are executed to update the appropriate information within the media player. Examples of the information that would be updated include the album art, title, and author is the current event happened to be a song. If the event is a song then Set Previous Played Information [435] software is executed to insert the song's title, author, and e-commerce link into a list to be accessed by the media player.

When the synchronized event message event handler is call with a replaceable advertisement event, the duration and time remaining information in the synchronized event message is examined if enough time exists in the broadcast stream to play a replacement advertisement. If not, the event handler exists. Otherwise, the replacement ad queue is examined to locate the next replacement advertisement of the appropriate time to fill the advertisement spot within the broadcast stream. If an advertisement of the appropriate length or lengths (i.e. two 30 second spots for one 60 second spot) is un-available, the event handler exits. Play Advertisement [410] software block is executed for the advertisement located within the ad queue matching the length of the advertisement spot.

To play and replacement advertisement Play Advertisement [410] software block first mutes the audio or audiovisual broadcast stream, un-mutes the replacement advertisement, then plays the replacement advertisement. When the media player begins playing the replacement advertisement, as in the playing of the pre-roll advertisement, it signals the Advertising Computer and reports a “click” for the third (prefetch/start) advertisement. The Advertising Computer responds with a hyperlink to an advertisement, and the media player connects to that streaming computer [by way of example, 240]. When the media player completes playing the replacement advertisement, it reports a “click” for the second (Comp Imp) advertisement. If a user happens to have clicked on the player during the advertisement, that information is reported in the first (Click) advertisement. When the replacement advertisement is finished playing the replacement advertisement media player is muted and the audio or audiovisual stream media player is un-muted, thus, allowing the broadcast stream, which continued to stream, to be heard by the user.

With the replacement advertisement finished playing an ad queue opening is now available for a new replacement advertisement is available and Pre-fetch Advertisement [415] software is executed to initiate the filling of the open ad queue slot. The process was previously defined; see Build Ad Queues [315] description.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A computer for communicating with a computer network and present information received from the network to a computer user, said computer comprising:
a processor;
a plurality of memory locations;
a network interface;
a media player adapted to receive live broadcast information from said computer interface and present the live broadcast information to the computer user; and
advertisement insertion means operably coupled to said network interface and said media player for requesting at least one insertable advertisement capable of insertion into the live broadcast information, for receiving at least one insertable advertisement, for storing said at least one insertable advertisement in said plurality of memory locations, for monitoring the live broadcast to determine portions of the live broadcast suitable for insertion of one of said at least one insertable advertisement, and for enabling said media player to present the at least one insertable advertisement to the computer user.

2. The computer of claim 1 wherein said advertisement insertion means further includes means for obtaining profile information relating to the computer user and transmitting said profile information through said network interface as part of a request for the at least one insertable advertisement.

3. The computer of claim 1 further comprising means for logging the presentation of the at least one insertable advertisement by said media player.

4. The computer of claim 3 wherein said logging means further logs the completion of the presentation of the at least one insertable advertisement by said media player.

5. In computer having a media player for presenting information to a computer user and an interface to a computer network capable of transferring live broadcast information, a method of inserting advertisements into the live broadcast information, said method comprising the steps of:
receiving at least one insertable advertisement capable of insertion into the live broadcast information;
presenting the live broadcast information to the computer user by the media player;
monitoring the live broadcast to determine portions of the live broadcast suitable for insertion of one of said at least one insertable advertisement; and
enabling the media player to present the at least one insertable advertisement to the computer user.

6. The method of claim 5 wherein said receiving step includes storing at least one insertable advertisement in the computer.

7. The method of claim 5 wherein the live broadcast information includes signals indicating an insertion portion which is suitable for insertion of an advertisement, and wherein said receiving step is performed prior to said enabling step.

8. The method of claim 7 wherein said receiving step includes storing the insertable advertisement for later presentation.

9. The method of claim 5 further comprising the step of logging the presentation of the insertable advertisement.

10. The method of claim 9 wherein said logging step includes the step of logging the completion of the insertable advertisement.

11. A machine-readable program storage device for storing encoded instructions for a method of a method of inserting advertisements into live broadcast information transferred over a computer network, the machine-readable program capable of executing on a computer having a media player for presenting information to a computer user, said method comprising the steps of:
receiving at least one insertable advertisement capable of insertion into the live broadcast information;
presenting the live broadcast information to the computer user by the media player;
monitoring the live broadcast to determine portions of the live broadcast suitable for insertion of one of said at least one insertable advertisement; and
enabling the media player to present the at least one insertable advertisement to the computer user.

12. The machine-readable program storage device of claim 11 wherein said receiving step includes storing the at least one insertable advertisement in the computer.

13. The machine-readable program storage device of claim 11 wherein the live broadcast information includes signals indicating an insertion portion which is suitable for insertion of an advertisement, and wherein said receiving step is performed prior to said enabling step.

14. The machine-readable program storage device of claim 13 wherein said receiving step includes storing the insertable advertisement for later presentation.

15. The machine-readable program storage device of claim 11 further comprising the step of logging the presentation of the insertable advertisement.

16. The machine-readable program storage device of claim 15 wherein said logging step includes the step of logging the completion of the insertable advertisement.
